(19) United States
(12) Patent Application Publication
(10) Pub. No.: US 2026/0291993 A1
(43) Pub. Date: Sep. 24, 2026

(54) INFORMATION PROCESSING DEVICE, INFORMATION PROCESSING METHOD, AND RECORDING MEDIUM

(71) Applicant: Panasonic Automotive Systems Co., Ltd., Kanagawa (JP)

(72) Inventors: Ryo HIRANO, Osaka (JP); Tomonori MITSUGI, Tokyo (JP)

(73) Assignee: Panasonic Automotive Systems Co., Ltd., Kanagawa (JP)

(21) Appl. No.: 19/430,985

(22) Filed: Dec. 23, 2025

(30) Foreign Application Priority Data
Mar. 18, 2025 (JP) 2025-043460

(51) Int. Cl. H04L 9/40; H04L 67/12

(52) U.S. Cl. CPC H04L 63/20; H04L 67/12

(57) ABSTRACT

An information processing device that generates a network communication policy used in an electronic control unit includes: an obtainer that obtains communication content and one or more types of network interfaces used by a program operating on the electronic control unit; a generator (e.g., a communication policy generator) that generates the network communication policy including a rule allowing, for the one or more types of network interfaces obtained, communication of the communication content obtained; and an outputter that outputs the network communication policy generated.

### CROSS REFERENCE TO RELATED APPLICATION

The present application is based on and claims priority of Japanese Patent Application No. 2025-043460 filed on Mar. 18, 2025.

### FIELD

The present disclosure relates to an information processing device, an information processing method, and a recording medium.

### BACKGROUND

Patent Literature (PTL) 1 discloses a device that sets rules edited by a user in a firewall device.

### Citation List

### Patent Literature

PTL 1: Japanese Patent No. 6193147

### SUMMARY

Devices etc. for manually generating network communication policies can be improved upon.

In view of this, the present disclosure provides an information processing device, an information processing method, and a recording medium capable of further improving upon the above related art.

An information processing device according to an aspect of the present disclosure is an information processing device that generates a network communication policy used in an electronic control unit, the information processing device including: an obtainer that obtains input data including communication content and one or more types of network interfaces, the communication content and the one or more types of network interfaces being used by a program operating on the electronic control unit; a generator that generates the network communication policy including a rule allowing, for the one or more types of network interfaces obtained, communication of the communication content obtained; and an outputter that outputs the network communication policy generated.

An information processing method according to an aspect of the present disclosure is an information processing method executed by an information processing device that generates a network communication policy used in an electronic control unit, the information processing method including: obtaining communication content and one or more types of network interfaces, the communication content and the one or more types of network interfaces being used by a program operating on the electronic control unit; generating the network communication policy including a rule allowing, for the one or more types of network interfaces obtained, communication of the communication content obtained; and outputting the network communication policy generated.

A recording medium according to an aspect of the present disclosure is a non-transitory computer-readable recording medium having recorded thereon a program for causing a computer to execute the foregoing information processing method.

According to an aspect of the present disclosure, it is possible to provide an information processing device, etc. capable of further improving upon the related art.

### BRIEF DESCRIPTION OF DRAWINGS

These and other advantages and features of the present disclosure will become apparent from the following description thereof taken in conjunction with the accompanying drawings that illustrate a specific embodiment of the present disclosure.

FIG. 1 is a diagram schematically illustrating an information processing system according to an embodiment.

FIG. 2 is a block diagram illustrating the functional structure of a vehicle system according to the embodiment.

FIG. 3 is a block diagram illustrating the functional structure of a policy generation device according to the embodiment.

FIG. 4 is a diagram illustrating an example of configuration information according to the embodiment.

FIG. 5 is a diagram illustrating an example of a communication list and threat analysis results according to the embodiment.

FIG. 6 is a diagram illustrating an example of a general-purpose policy according to the embodiment.

FIG. 7 is a flowchart illustrating the operation of the policy generation device according to the embodiment.

FIG. 8 is a diagram illustrating an example of a communication policy for external communication (development phase) according to the embodiment.

FIG. 9 is a diagram illustrating an example of a communication policy for internal communication (development phase) according to the embodiment.

FIG. 10 is a diagram illustrating an example of a communication policy for external communication (production phase) according to the embodiment.

FIG. 11A is a diagram illustrating an example of a communication policy for internal communication (production phase) according to the embodiment.

FIG. 11B is a diagram illustrating another example of a communication policy for internal communication (production phase) according to the embodiment.

### DESCRIPTION OF EMBODIMENT

### Circumstances Leading to the Present Disclosure

In recent years, vehicle systems mounted in vehicles have become increasingly complex in order to provide users with advanced vehicle functions such as autonomous driving. To address issues such as increased development periods and development costs associated with such increasingly complex vehicle systems, there has been a trend to integrate a plurality of functions, which have conventionally been distributed among a plurality of electronic control units (ECUs), into a single ECU. For example, a cockpit domain controller (CDC) that integrates functions such as infotainment system, cluster, and electronic mirror is expected in the market to meet high-speed communication requirements, reduce weight, and improve function development efficiency. A CDC may be implemented, for example, by a single ECU (e.g., virtualized ECU).

In integrating ECUs, virtualization or container technology may be used to implement, as virtual machines or containers, external connection functions and vehicle control functions mounted in the vehicle and separate software regions. However, vehicle functions often need to cooperate across virtual machines or containers, requiring communication between virtual machines or containers. It is therefore difficult to completely separate software regions. For example, functions may be implemented within virtual machines on a virtualization platform such as a hypervisor, and the virtual machines may be connected via a virtual network (NW).

Consider, for example, a case where communication between virtual machines or containers is enabled. In this case, if communication between virtual machines or containers is not properly managed, tampering with a virtual machine or container having an external connection function could lead to misuse of communication between virtual machines or containers, and cause damage to a virtual machine or container having a vehicle control function via internal communication. As a countermeasure, a firewall function is installed in the network. Such an ECU may include two or more virtual machines and/or two or more containers.

However, vehicle systems mounted in vehicles often include a variety of external and internal network interfaces (IFs), and also some communications differ between production phase and development phase. Understanding all communications and incorporating them into a firewall’s allow list (e.g., network communication policy) requires enormous and complex work. Default network communication policies used in firewalls basically deny all communications and allow only communications permitted in the allow list.

Examples of external network IFs include Long Term Evolution (LTE) (registered trademark), Wi-Fi Station Mode (Wi-Fi STA), Wi-Fi Access Point Mode (Wi-Fi AP), Universal Serial Bus (USB) (registered trademark), Bluetooth (BT) (registered trademark), and external Ethernet. Examples of internal network IFs include internal Ethernet, Unix Domain Socket communication, vsock, Inter-Process Communication (IPC), and message queues.

As mentioned above, it is not easy for persons to generate network communication policies used in firewalls in vehicle systems, etc. For example, in recent years, objects such as vehicles communicate with external devices. Manually generating network communication policies to be set in firewall devices used by such objects may require enormous and complex work.

In view of the above, the inventors of the present application have carefully studied an information processing device, etc. capable of easily generating network communication policies used in vehicle systems and the like, and conceived the below-described information processing device, etc. Specifically, the information processing device, etc. automatically generate network communication policies to improve the efficiency of the work of developers.

Certain exemplary embodiments will be described in detail below with reference to the drawings.

Each of the embodiments described below shows a general or specific example. The numerical values, shapes, structural elements, the arrangement and connection of the structural elements, steps, the processing order of the steps etc. illustrated in the following embodiments are mere examples, and do not limit the scope of the present disclosure. Of the structural elements in the embodiments described below, the structural elements not recited in any one of the independent claims will be described as optional structural elements.

The substantially same elements are given the same reference marks throughout the drawings, and repeated description is omitted or simplified.

In the specification, the terms indicating the relationships between elements, such as “same” and “equal”, the numerical values, and the numerical ranges are not expressions of strict meanings only, but are expressions of meanings including substantially equivalent ranges, for example, allowing for a difference of about several percent (or about 10%).

In the specification, ordinal numbers such as “first” and “second” do not mean the numbers or order of structural elements unless otherwise specified, but are used for the purpose of avoiding confusion and distinguishing between structural elements of the same type.

In the specification, for example, in cases where the expressions “greater than or equal to the threshold” and “less than the threshold” are contrasted with each other, the expressions indicate that the threshold serves as a boundary, and may mean “greater than the threshold” and “less than or equal to the threshold”, respectively.

### Embodiment

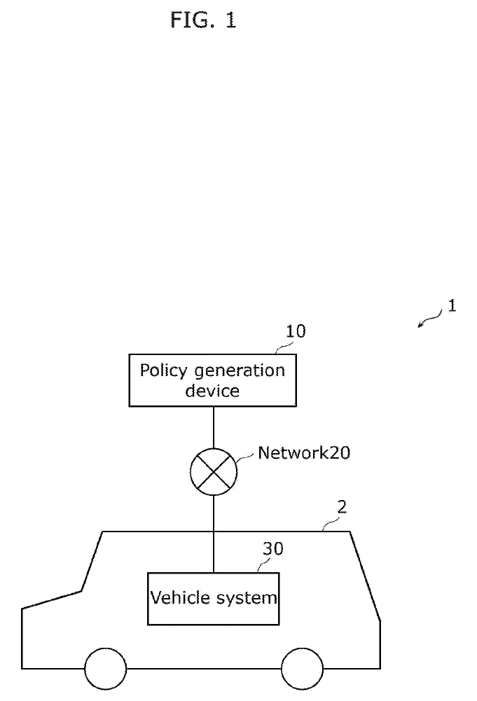

An information processing system, etc. according to this embodiment will be described below with reference to FIGS. 1 to 11B.

### 1. Structure of Information Processing System

First, the structure of the information processing system according to this embodiment will be described with reference to FIGS. 1 to 3. FIG. 1 is a diagram schematically illustrating information processing system 1 according to this embodiment.

As illustrated in FIG. 1, information processing system 1 includes policy generation device 10 and vehicle system 30. Policy generation device 10 and vehicle system 30 are communicably connected to each other via network 20.

Policy generation device 10 is an information processing device that generates network communication policies (also referred to as communication policies) used (e.g., installed) in an electronic control unit mounted in vehicle 2, such as communication policies for a firewall or communication filter. In this embodiment, policy generation device 10 is used to generate communication policies used in a firewall within vehicle system 30. Policy generation device 10 may be implemented by a personal computer (PC) or implemented as software on a server. Vehicle 2 is an example of a mobile object.

Network 20 is, for example, the Internet. The communication scheme of network 20 may be wired or wireless. Examples of the wireless communication scheme include existing technologies such as Wi-Fi (registered trademark), 3G/LTE (registered trademark), Bluetooth (registered trademark), and V2X communication method.

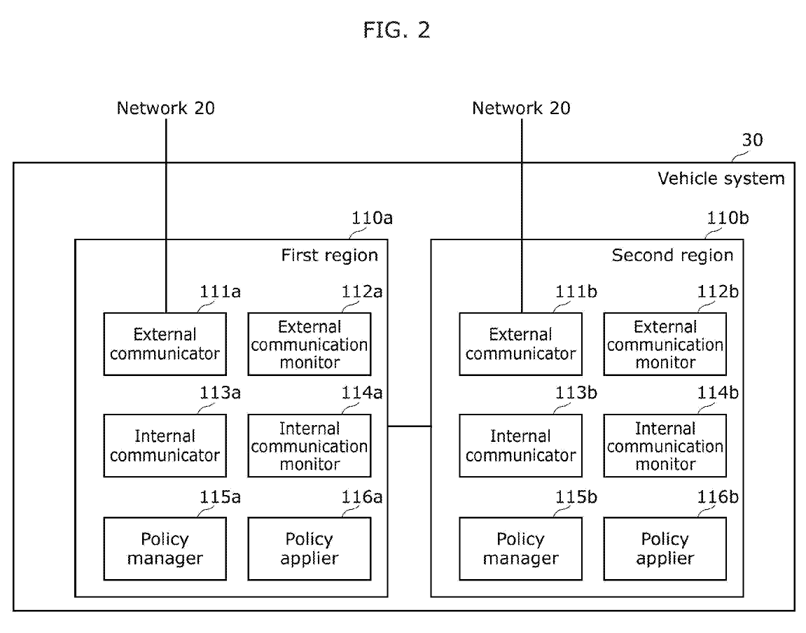

A communication policy generated is delivered to a policy applier (see FIG. 2 described later) in vehicle 2 via network 20, so that the communication policy is enabled in vehicle system 30. The policy applier is a device that applies the communication policy to an electronic control unit in vehicle system 30.

Vehicle system 30 is mounted in (provided to) vehicle 2 such as an automobile. Vehicle system 30 may be a device that implements driving functions of vehicle 2, such as running, turning, and stopping. One or more electronic control units are mounted in (provided to) vehicle system 30. Software is installed in the electronic control units, and vehicle functions are implemented by controlling communication inside and outside vehicle 2.

FIG. 2 is a block diagram illustrating the functional structure of vehicle system 30 according to this embodiment.

As illustrated in FIG. 2, vehicle system 30 includes first region 110a and second region 110b, which are software regions in vehicle system 30 (e.g., software regions defined by the electronic control units or by the software in the electronic control units). First region 110a and second region 110b perform internal communication for functional cooperation across software regions. For example, first region 110a and second region 110b are communicably connected to each other via a firewall. First region 110a and second region 110b also perform external communication to communicate with devices outside vehicle 2.

First region 110a includes external communicator 111a, external communication monitor 112a, internal communicator 113a, internal communication monitor 114a, policy manager 115a, and policy applier 116a. Second region 110b has the same structure as first region 110a, and specifically includes external communicator 111b, external communication monitor 112b, internal communicator 113b, internal communication monitor 114b, policy manager 115b, and policy applier 116b. The structural elements will be described below using first region 110a as an example.

External communicator 111a communicates with devices outside vehicle 2. External communicator 111a communicates with servers outside the vehicle, ECUs inside the vehicle, and mobile terminals such as smartphones, for example, via Internet communication such as LTE (registered trademark) or Wi-Fi STA, communication using physical Ethernet (registered trademark), or Bluetooth (registered trademark), Wi-Fi AP, or USB (registered trademark) connection.

External communication monitor 112a monitors transmission and reception of external communication, and blocks communication that is not defined in a communication policy for external communication. Communication that is not defined in the communication policy for external communication means communication for which no rule allowing communication is included in the communication policy for external communication. External communication monitor 112a can be regarded as having a firewall function.

Internal communicator 113a communicates with devices inside vehicle 2. Internal communicator 113a performs, for example, communication using virtual Ethernet (registered trademark), Unix Domain Socket communication, vsock, message queues, or IPC.

Internal communication monitor 114a monitors transmission and reception of internal communication, and blocks communication that is not defined in a communication policy for internal communication. For example, internal communication monitor 114a monitors communication between two or more virtual machines and/or communication between two or more containers, and communication from one of a virtual machine and a container to the other, by applying the corresponding communication policy. Communication that is not defined in the communication policy for internal communication means communication for which no rule allowing communication is included in the communication policy for internal communication. Internal communication monitor 114a can be regarded as having a firewall function.

Even with the same Ethernet (registered trademark) communication, there may be a plurality of network interfaces (physical ports) or a plurality of virtual network interfaces, or different communication protocols such as SOME/IP and HTTP may be used.

Policy manager 115a receives the communication policies output from policy generation device 10, and stores and manages the communication policies.

Policy applier 116a applies communication policies for network interfaces and communication protocols, to external communication monitor 112a and internal communication monitor 114a.

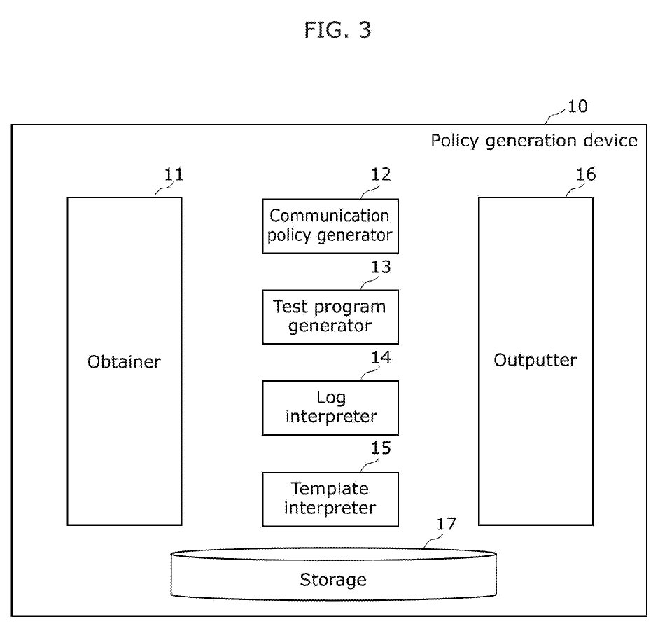

Next, the structure of policy generation device 10 will be described with reference to FIG. 3. FIG. 3 is a block diagram illustrating the functional structure of policy generation device 10 according to this embodiment. The functional structure of policy generation device 10 illustrated in FIG. 3 is an example, and the functional structure of policy generation device 10 is not limited to that in FIG. 3.

As illustrated in FIG. 3, policy generation device 10 includes obtainer 11, communication policy generator 12, test program generator 13, log interpreter 14, template interpreter 15, outputter 16, and storage 17. At least some of the functional units included in policy generation device 10 are implemented by a processor (e.g., CPU) included in policy generation device 10 executing a program using a memory.

Obtainer 11 obtains information (input data) necessary for generating a communication policy. For example, obtainer 11 obtains information indicating communication content and one or more types of network interfaces used by a program operating on an electronic control unit (e.g., a program operating on a virtual machine). The expression “communication content and one or more types of network interfaces used by a program” herein refers to information (or hardware) used when the program performs communication. The communication content is information necessary for information transmission and reception, and is header information in communication. The communication content does not include information subjected to transmission and reception, such as control data of devices. The one or more types of network interfaces may be, for example, two or more types of network interfaces. For example, obtainer 11 may include a communication circuit (or communication module) and obtain the information via network 20. Obtainer 11 functions as a receiver that receives input data.

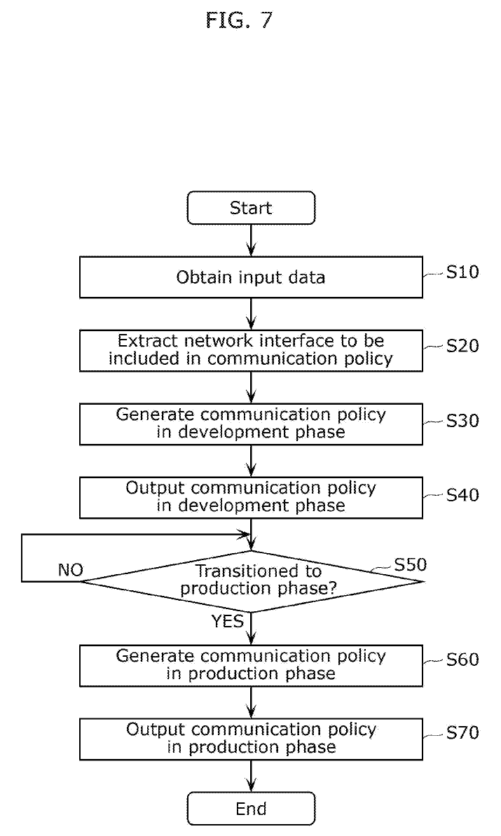

Obtainer 11 may also obtain communication logs of communication in vehicle system 30, as input data. Obtainer 11 may also obtain templates of communication policies corresponding to respective deployment targets and/or respective communication protocols. For example, obtainer 11 may obtain a plurality of templates before execution of Step S30 illustrated in FIG. 7 (described later). The communication logs and the plurality of templates may be stored in storage 17.

Communication policy generator 12 generates a communication policy using the input data. Communication policy generator 12 generates a communication policy that includes a rule allowing, for the obtained one or more types of network interfaces, communication of the communication content. When obtainer 11 obtains information about two or more types of network interfaces, communication policy generator 12 may generate a communication policy that includes a rule allowing, for at least one (e.g., all) of the two or more types of network interfaces, communication of the communication content.

Communication policy generator 12 may generate the communication policy using a format in accordance with at least one of the deployment target (e.g., software region) of the program operating on the virtual machine or container or the communication protocol. The communication policy is generated by inputting desired information to the format in accordance with the deployment target. For example, communication policy generator 12 uses a format that differs for each virtual machine or container or for each communication protocol, to generate a communication policy. A communication policy generation method will be described later. Communication policy generator 12 is an example of a generator.

Test program generator 13 generates a test pattern to verify the communication policy generated by communication policy generator 12. The test pattern may include, for example, the communication content and the network interfaces. Test program generator 13 functions as the generator.

Log interpreter 14 interprets communication logs and generates a communication policy. That is, policy generation device 10 has a function of generating a communication policy using communication logs as input data. Log interpreter 14 functions as the generator.

For example, log interpreter 14 generates a communication policy that includes a rule allowing at least one of a plurality of communications included in communication logs during a predetermined period. Log interpreter 14 may generate, for example, a communication policy that includes a rule allowing all of the plurality of communications included in the communication logs during the predetermined period. For example, log interpreter 14 may generate a communication policy that includes a rule allowing one or more communications among communications denied in the communication policy generated by communication policy generator 12. The one or more communications to be allowed by log interpreter 14 may be selected by a user. In other words, log interpreter 14 may obtain a selection of one or more communications to be allowed from the user, and generate a communication policy that includes a rule allowing the selected one or more communications. Log interpreter 14 may use communication logs in any of a production phase and a development phase.

Template interpreter 15 interprets a template (e.g., description format) to generate a template for a communication policy (i.e., communication policy template). Since communication policy templates may differ depending on the deployment target of the program operating on the virtual machine or container, the communication protocol, and the like, template interpreter 15 generates a communication policy template in accordance with the deployment target, the communication protocol, and the like. For example, when the communication protocol is TCP/IP, template interpreter 15 generates a template that can be handled by a module having a firewall function for packet communication. The communication protocol is not limited to TCP/IP, and may be the User Datagram Protocol (UDP), an in-vehicle protocol, or any other communication protocol.

For example, having received input of a currently used template, template interpreter 15 can interpret the template and output the same template. Thus, communication policies can be generated using the same template.

Outputter 16 outputs the communication policy generated by communication policy generator 12 (or by log interpreter 14) to vehicle 2. In the case where verification of the generated communication policy is to be performed using vehicle 2, outputter 16 may also output the test pattern generated by test program generator 13 to vehicle 2. For example, outputter 16 includes a communication circuit (or communication module) and outputs various information to vehicle 2 via network 20.

Storage 17 is a storage device that stores various information used for generating communication policies. Storage 17 may store, for example, input data and communication logs. Storage 17 is implemented, for example, by a non-volatile storage device such as a solid state drive (SSD) or hard disk drive (HDD).

Policy generation device 10 includes at least communication policy generator 12 and outputter 16.

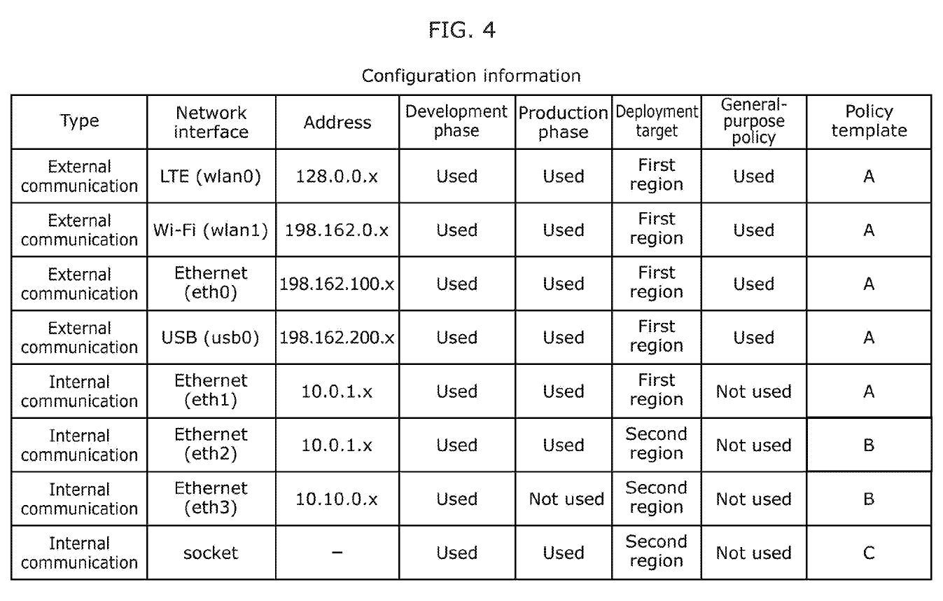

Various information stored in storage 17 will be described with reference to FIGS. 4 to 6. FIG. 4 is a diagram illustrating an example of configuration information according to this embodiment.

As illustrated in FIG. 4, the configuration information of vehicle system 30 is an example of input data, and includes the following items: type, network interface, address, development phase, production phase, deployment target, general-purpose policy, and policy template.

The “type” indicates the type of communication, and includes external communication, i.e., communication with a device outside vehicle system 30 (e.g., outside vehicle 2), and internal communication, i.e., communication within vehicle system 30.

The “network interface” indicates the type of network interface, and indicates, for example, at least one of the communication standard (e.g., communication protocol) or network adapter used for communication. Network interfaces include LTE (registered trademark), Wi-Fi (registered trademark), Ethernet (registered trademark), USB (registered trademark), and socket, for example. Names such as “wlan0” and “eth0” are network adapter names. “wlan” stands for wireless local area network.

The “address” is the address of the source or destination.

The “development phase” indicates whether the network interface is used in the development phase (e.g., design information). The development phase is the period during which vehicle system 30 is developed by its developer. The entry is “used” if the network interface is used in the development phase, and “not used” if the network interface is not used in the development phase.

The “production phase” indicates whether the network interface is used in the production phase (e.g., design information). The production phase is the period during which vehicle system 30 is sold and used by its user. The entry is “used” if the network interface is used in the production phase, and “not used” if the network interface is not used in the production phase.

The “deployment target” indicates the region to which the network interface belongs. Regions include first region 110a and second region 110b. The number of regions may be three or more. The operating system (OS) and communication protocol may differ depending on the virtual machine or container. Since the firewall mechanism (e.g., template) varies depending on the OS and communication protocol, the firewall temperate may differ depending on, for example, whether the OS is Linux or Windows. Accordingly, information of the deployment target is used to identify the communication policy template. The deployment target can be regarded as indicating which virtual machine or container within vehicle system 30 the network interface belongs to.

If the configuration information includes the item “policy template”, the item “deployment target” may be omitted in the configuration information. First region 110a and second region 110b in FIG. 2 are examples of regions.

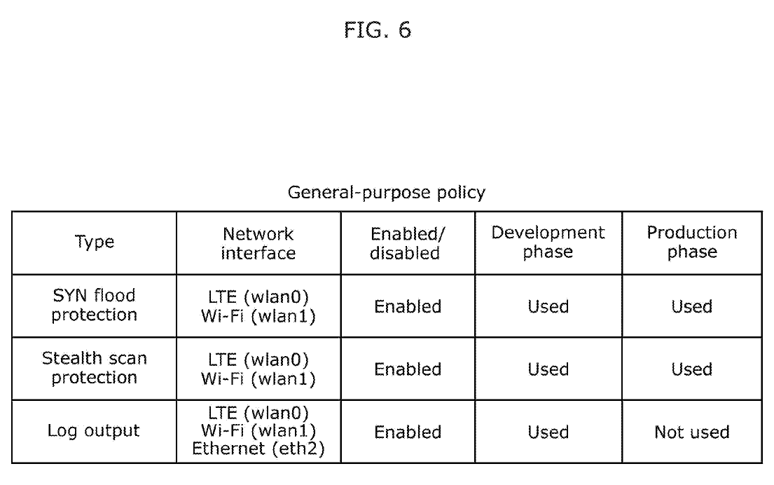

The “general-purpose policy” indicates whether a general-purpose policy illustrated in FIG. 6 (described below) is used. The general-purpose policy is a policy that can be commonly used regardless of the communication content, for example, a policy that does not depend on the network interface or deployment target.

The “policy template” indicates which template is to be used to generate the communication policy. The policy template is information based on a format.

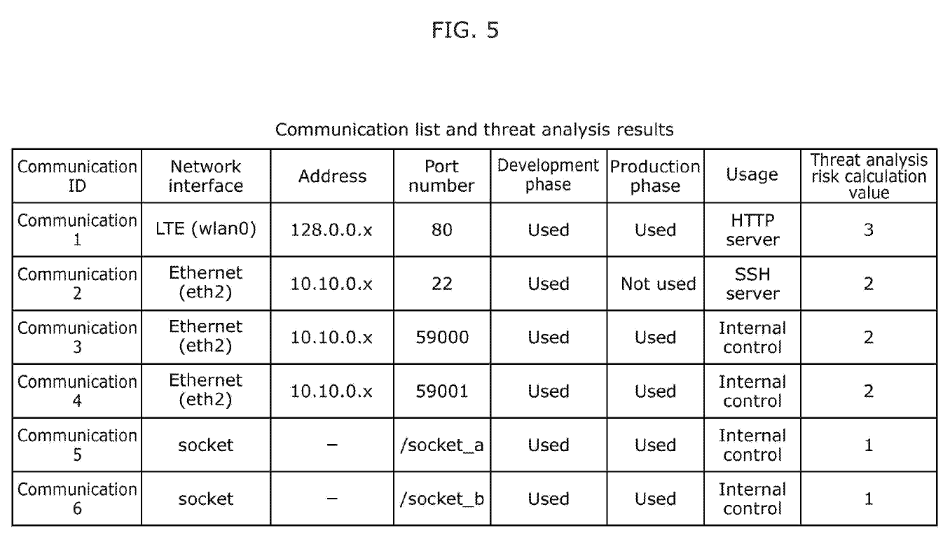

FIG. 5 is a diagram illustrating an example of a communication list and threat analysis results according to this embodiment.

As illustrated in FIG. 5, the communication list and threat analysis results are an example of input data, and include the following items: communication ID, network interface, address, port number, development phase, production phase, usage, and threat analysis risk calculation value. In this specification, the communication list includes information from “communication ID” to “usage”, and the communication content includes at least one from among (e.g., all of) “communication ID”, “network interface”, “address”, and “port number”. The “network interface”, “address”, “development phase”, and “production phase” are the same as those in FIG. 4, and accordingly their description is omitted.

The “communication ID” is identification information for identifying the communication. In FIG. 5, six communication logs are included.

The “port number” is a number for identifying the service (or program) used for communication by vehicle system 30 (e.g., electronic control unit). In TCP/IP communication, the IP address corresponds to the port number. In socket communication, the path of the socket file corresponds to the port number.

The “usage” indicates the intended use of the communication. For example, “HTTP server” indicates communication for exchanging information with a Hypertext Transfer Protocol (HTTP) server, which is external communication with reference to FIG. 4. “SSH server” indicates communication for exchanging information with a Secure Shell (SSH) server, which is internal communication with reference to FIG. 4. “Internal control” indicates communication for controlling devices inside vehicle 2, which is internal communication with reference to FIG. 4.

The “threat analysis risk calculation value” is a value indicating the result of threat analysis, for example, a value indicating the risk of the communication. The threat analysis risk calculation value can also be regarded as a degree indicating whether the communication content needs to be protected. The analysis result (threat analysis result) includes, for example, a result of analyzing how significant the security threat would be if the communication were hijacked. A higher numerical value indicates a higher risk. Determination can be made as follows: If the threat analysis risk calculation value is high (e.g., 3), protection is required because the possibility of malicious use is high. If the threat analysis risk calculation value is low (e.g., 1), protection is not required because the risk is low.

The threat analysis risk calculation value is associated on a one-to-one basis with the network interface. Hence, the threat analysis risk calculation value is used to determine, for example, whether to include the network interface in the communication policy. The threat analysis risk calculation value may be set according to usage, deployment target, and the like.

FIG. 6 is a diagram illustrating an example of a general-purpose policy according to this embodiment.

As illustrated in FIG. 6, the general-purpose policy is an example of input data and includes the following items: type, network interface, enabled/disabled, development phase, and production phase. The “network interface", “development phase”, and “production phase” are the same as those in FIG. 4, and accordingly their description is omitted.

The “type” indicates the type of processing performed as the general-purpose policy and includes SYN flood protection, stealth scan protection, and log output.

The “SYN flood protection” indicates a countermeasure against a SYN flood attack, which is a type of DDoS attack.

The “stealth scan protection” indicates a countermeasure against stealth scanning, which is a type of port scanning.

The “log output” indicates whether to record logs for communications blocked by the firewall.

The “enabled/disabled” indicates whether the processing indicated by the type is enabled.

The general-purpose policy can also be regarded as including a rule related to SYN flood protection (the content in the first row of FIG. 6), a rule related to stealth scan protection (the content in the second row of FIG. 6), and a rule related to settings for log output (the content in the third row of FIG. 6).

For example, in the first row, SYN flood protection is enabled in both the development phase and the production phase, indicating that SYN flood protection is executed in both the development phase and the production phase.

The general-purpose policy is information independent of the information of the communication list, and is not generated using the information of the communication list.

At least one of the information illustrated in FIG. 4, the information illustrated in FIG. 5, or the information illustrated in FIG. 6 may be obtained in advance and stored in storage 17.

### 2. Operation of Information Processing System

Next, the operation of information processing system 1 having the above-described structure will be described with reference to FIGS. 7 to 11B. FIG. 7 is a flowchart illustrating the operation (information processing method) of policy generation device 10 according to this embodiment. It is assumed that the time at which Step S10 starts corresponds to the development phase.

As illustrated in FIG. 7, obtainer 11 obtains input data (S10). Obtainer 11 obtains, for example, at least one set of information illustrated in FIGS. 4 to 6 as input data, via network 20 or by receiving user input. The timing at which obtainer 11 obtains the input data is not particularly limited.

The input data may be obtained in advance and stored in storage 17. In this case, communication policy generator 12 may obtain the input data by reading the input data from storage 17.

Next, communication policy generator 12 extracts one or more network interfaces to be included in a communication policy (S20). Communication policy generator 12 extracts one or more network interfaces to be included in the communication policy from among a plurality of network interfaces, based on the threat analysis risk calculation values in the table illustrated in FIG. 5. For example, communication policy generator 12 extracts each network interface having a threat analysis risk calculation value greater than or equal to a threshold (e.g., 2), as a network interface to be included in the communication policy.

In the example in FIG. 5, communication policy generator 12 extracts two or more network interfaces having a threat analysis risk calculation value of 2 or more, namely, Long Term Evolution (LTE) (registered trademark) and Ethernet (registered trademark), as network interfaces to be included in the communication policy.

The network interface extraction method for generating the communication policy is not limited to this. For example, a predetermined number of network interfaces with the highest threat analysis risk calculation values may be extracted as the network interfaces to be included in the communication policy, or network interfaces may be added and deleted by the user. Network interfaces may be extracted by any other method.

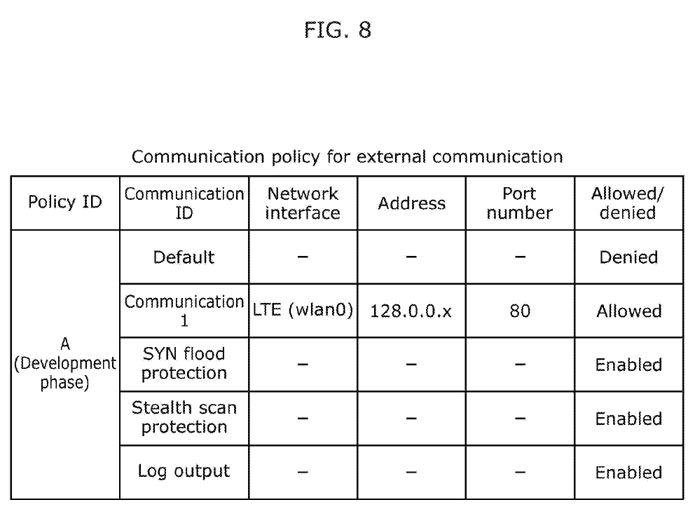

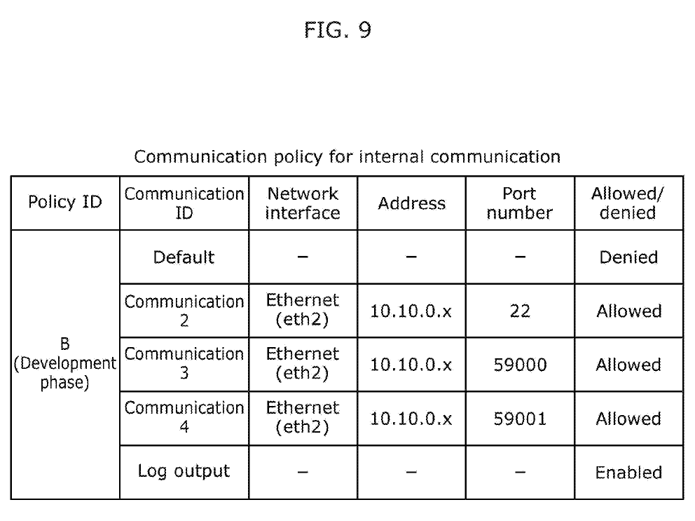

Next, communication policy generator 12 generates a communication policy in a development phase based on the input data (S30). The generation of the communication policy in the development phase will be described with reference to FIGS. 8 and 9. The communication policy in the development phase is a development-only network communication policy used in the development phase of vehicle system 30. In FIG. 8, each row represents one rule. For example, one rule includes the following items: communication ID, network interface, address, port number, and allowed/denied (e.g., setting).

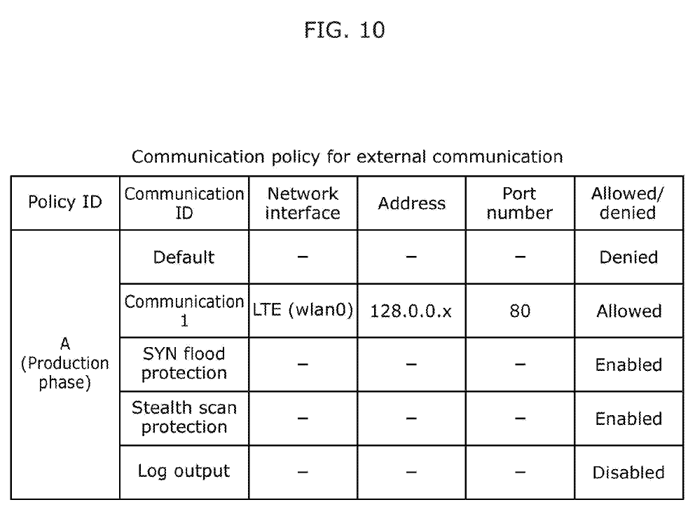

FIG. 8 is a diagram illustrating an example of a communication policy for external communication (development phase) according to this embodiment. In FIGS. 8 and 10, the policy ID of the communication policy based on template “A” is “A”. The default setting for the communication policy is “denied”. In other words, if allowed communication is not included, all communications are blocked by the firewall.

As illustrated in FIG. 8, the communication policy for external communication is a communication policy used in the development phase, and includes the following items: policy ID, communication ID, network interface, address, port number, and allowed/denied. Since the communication corresponding to communication 1 is allowed, communications other than communication 1 are denied by default. Thus, the communication policy includes whether communication is allowed for each of the two or more types of network interfaces.

Moreover, since SYN flood protection, stealth scan protection, and log output are enabled, SYN flood protection, stealth scan protection, and log output are executed. Communication policy generator 12 generates the communication policy illustrated in FIG. 8 in the following manner.

First, communication policy generator 12 extracts each network interface used for external communication in the development phase and having a threat analysis risk calculation value greater than or equal to the threshold (2 in this example), based on the “type” and “network interface” fields in FIG. 4 and the “threat analysis risk calculation value” field in FIG. 5. Here, “LTE (wlan0)” is extracted. Communication policy generator 12 then obtains information that “LTE (wlan0)” is “used” in the development phase based on the “development phase” field in FIG. 5, and reflects this information in the communication policy.

Further, communication policy generator 12 determines whether to use the general-purpose policy in the development phase for external communication, based on FIG. 6. Communication policy generator 12 obtains, based on FIG. 6, information that SYN flood protection, stealth scan protection, and log output corresponding to “LTE (wlan0)” are enabled and are “used” in the development phase, and reflects this information in the communication policy.

As a result, a communication policy is generated in which communication 1 is allowed and SYN flood protection, stealth scan protection, and log output are enabled, as illustrated in FIG. 8. The rules in the general-purpose policy are thus included in the communication policy.

Communication policy generator 12 generates a communication policy in a format consistent with a template generated by template interpreter 15 and identified based on “deployment target” and the like in FIG. 4. That is, communication policy generator 12 converts the content illustrated in FIG. 8 into a format consistent with the template (template A in this example). In the case where a plurality of templates are stored in storage 17, communication policy generator 12 may select, from among the plurality of templates, a template corresponding to at least one of the obtained deployment target or communication protocol, and generate the communication policy in accordance with the selected template.

FIG. 9 is a diagram illustrating an example of a communication policy for internal communication (development phase) according to this embodiment.

As illustrated in FIG. 9, the communication policy for internal communication is a communication policy used in the development phase. Communication policy generator 12 generates the communication policy illustrated in FIG. 9 in the following manner.

First, communication policy generator 12 extracts each network interface used for internal communication in the development phase and having a threat analysis risk calculation value greater than or equal to the threshold (2 in this example), based on the “type” and “network interface” fields in FIG. 4 and the “threat analysis risk calculation value” field in FIG. 5. Here, “Ethernet (eth2)” is extracted. Communication policy generator 12 then obtains information that “Ethernet (eth2)” is “used” in the development phase based on the “development phase” field in FIG. 5, and reflects this information in the communication policy. Since communication IDs corresponding to “Ethernet (eth2)” are communications 2 to 4, these are reflected in the communication policy.

Further, communication policy generator 12 determines whether to use the general-purpose policy in the development phase for internal communication, based on FIG. 6. Communication policy generator 12 obtains, based on FIG. 6, information that log output corresponding to “Ethernet (eth2)” is enabled and is “used” in the development phase, and reflects this information in the communication policy.

As a result, a communication policy is generated in which communications 2 to 4 are allowed and log output is enabled, as illustrated in FIG. 9.

Thus, communication policy generator 12 identifies communication to be protected (e.g., communication requiring protection) based on the threat analysis risk calculation value and generates a communication policy that includes a rule allowing only the identified communication.

Communication policy generator 12 generates a communication policy in a format consistent with a template generated by template interpreter 15 and identified based on “deployment target” and the like in FIG. 4. That is, communication policy generator 12 converts the content illustrated in FIG. 9 into a format consistent with the template. Here, based on the policy template illustrated in FIG. 4, a template different from that used in Step S30 is used.

In Step S30, log interpreter 14 may interpret communication logs of communications performed prior to Step S10 to generate a communication policy. For example, log interpreter 14 may monitor packets flowing on the network, obtain communication logs using tcpdump which is a command for packet obtainment, and generate a communication policy that allows one or more communications (e.g., all communications) included in the communication logs, in addition to the communication list illustrated in FIG. 5. Log interpreter 14 may add rules based on the communication logs to the communication policy generated by communication policy generator 12, or generate another communication policy separate from the communication policy generated by communication policy generator 12. By using tcpdump, information such as network interface, address, port number, and usage in the packet can be obtained.

In Step S30, communication policy generator 12 generates at least one of the communication policy for external communication or the communication policy for internal communication.

Returning to FIG. 7, next, outputter 16 outputs the generated communication policy (communication policy for external communication in this example) to vehicle system 30 (S40). The communication policy output here is a communication policy in a format consistent with the template.

Next, communication policy generator 12 determines whether the operation has transitioned from the development phase to the production phase, for example, whether the development period has ended (S50). For example, when communication policy generator 12 obtains, via obtainer 11, information indicating that the development period of vehicle 2 has ended, communication policy generator 12 determines that the operation has transitioned from the development phase to the production phase. However, the determination method is not limited to this.

The determination result in Step S50 represents an example of product requirement information indicating whether the communication content and the one or more types of network interfaces are to be included in a product. The product requirement information may be information indicating whether the communication content and the one or more types of network interfaces need to be included in a product. A determination result of “Yes” in Step S50 indicates that the communication content and the one or more types of network interfaces are included in the product. A determination result of “No” in Step S50 indicates that the communication content and the one or more types of network interfaces are not included in the product (e.g., not included in the product at the time of the determination). The determination in Step S50 may be performed by a device outside policy generation device 10, and policy generation device 10 may obtain the determination result. Step S50 may be omitted. In this case, the communication policy in the development phase and the communication policy in the production phase may be output.

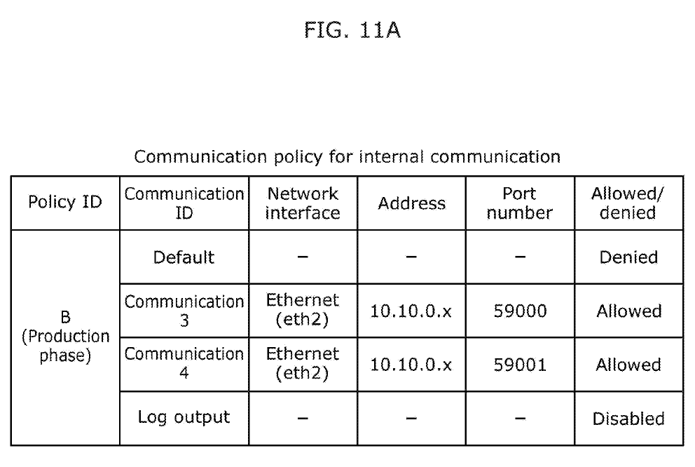

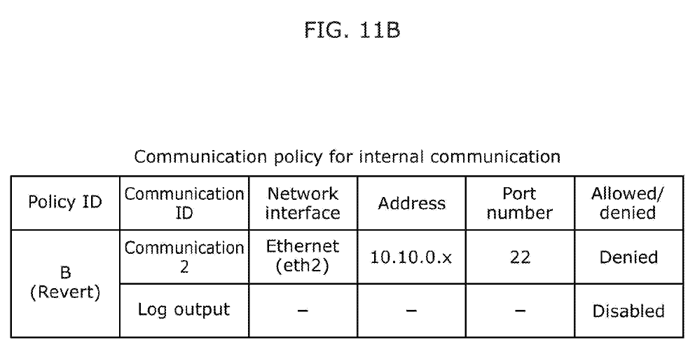

In the case where it is determined that the operation has transitioned from the development phase to the production phase (Yes in Step S50), communication policy generator 12 generates a communication policy in the production phase based on the input data (S60). In the case where it is determined that the operation has not transitioned from the development phase to the production phase (No in Step S50), communication policy generator 12 returns to Step S50 and performs the process from Step S50 onward. The communication policy in the production phase is a production network communication policy used in the product (vehicle system 30 in this example). The generation of the communication policy in the production phase will be described with reference to FIGS. 10 to 11B.

FIG. 10 is a diagram illustrating an example of a communication policy for external communication (production phase) according to this embodiment. The items of the communication policy are the same as those in FIG. 8, and accordingly their description is omitted.

As illustrated in FIG. 10, the communication policy for external communication is a communication policy used in the production phase. Communication policy generator 12 generates the communication policy illustrated in FIG. 10 in the following manner.

First, communication policy generator 12 extracts each network interface used for external communication in the production phase and having a threat analysis risk calculation value greater than or equal to the threshold (2 in this example), based on the “type” and “network interface” fields in FIG. 4 and the “threat analysis risk calculation value” field in FIG. 5. Here, “LTE (wlan0)” is extracted. Communication policy generator 12 then obtains information that “LTE (wlan0)” is “used” in the production phase based on the “production phase” field in FIG. 5, and reflects this information in the communication policy.

Further, communication policy generator 12 determines whether to use the general-purpose policy in the production phase for external communication, based on FIG. 6. Communication policy generator 12 obtains, based on FIG. 6, information that SYN flood protection and stealth scan protection corresponding to “LTE (wlan0)” are enabled and are “used” in the production phase, and reflects this information in the communication policy. In addition, communication policy generator 12 obtains, based on FIG. 6, information that log output corresponding to “LTE (wlan0)” is enabled but is “not used” in the production phase, and reflects this information in the communication policy.

As a result, a communication policy is generated in which communication 1 is allowed, SYN flood protection and stealth scan protection are enabled, and log output is disabled, as illustrated in FIG. 10.

Communication policy generator 12 generates a communication policy in a format consistent with a template generated by template interpreter 15 and identified based on “deployment target” and the like in FIG. 4. That is, communication policy generator 12 converts the content illustrated in FIG. 10 into a format consistent with the template.

FIGS. 11A and 11B are each a diagram illustrating an example of a communication policy for internal communication (production phase) according to this embodiment. The communication policy for internal communication illustrated in FIG. 11A is a communication policy used in the production phase. When the operation transitions from the development phase to the production phase, the communication policy used in vehicle system 30 is switched from the communication policy illustrated in FIG. 9 to the communication policy illustrated in FIG. 11A. The communication policy for internal communication illustrated in FIG. 11B is a communication policy used in the production phase together with the communication policy illustrated in FIG. 9, and includes only the changes from the communication policy illustrated in FIG. 9. When the operation transitions from the development phase to the production phase, the communication policy illustrated in FIG. 11B is added to the communication policy used in vehicle system 30. Either of the communication policies illustrated in FIGS. 11A and 11B is generated as the communication policy for internal communication (production phase).

As illustrated in FIG. 11A, the communication policy for internal communication is a communication policy used in the production phase. Communication policy generator 12 generates the communication policy illustrated in FIG. 11A in the following manner.

First, communication policy generator 12 extracts each network interface used for internal communication in the production phase and having a threat analysis risk calculation value greater than or equal to the threshold (2 in this example), based on the “type” and “network interface” fields in FIG. 4 and the “threat analysis risk calculation value” field in FIG. 5. Here, “Ethernet (eth2)” is extracted. Communication policy generator 12 then obtains information that communications 3 and 4 of “Ethernet (eth2)” are “used” in the production phase and communication 2 of “Ethernet (eth2)” is “not used” in the production phase based on the “production phase” field in FIG. 5,, and reflects this information in the communication policy.

Further, communication policy generator 12 determines whether to use the general-purpose policy in the production phase for internal communication, based on FIG. 6. Communication policy generator 12 obtains, based on FIG. 6, information that log output corresponding to “Ethernet (eth2)” is enabled but is “not used” in the production phase, and reflects this information in the communication policy.

As a result, a communication policy is generated in which communications 3 and 4 are allowed and log output is disabled, as illustrated in FIG. 11A. In this case, when communication of communication 2 occurs, the communication is denied by default determination.

As illustrated in FIG. 11B, the communication policy for internal communication is a communication policy used in the production phase. Communication policy generator 12 generates the communication policy illustrated in FIG. 11B in the following manner.

First, communication policy generator 12 determines, for each of the communication IDs included in FIG. 9 except for the default, whether the “used/not used” status changes between the development phase and the production phase. Communication policy generator 12 extracts, among communications 2 to 4 and log output in FIG. 9, each communication ID for which the “used/not used” status changes with reference to FIGS. 5 and 6. In FIGS. 5 and 6, communication 2 and log output are extracted as communication IDs for which the “used/not used” status changes. The communication policy for internal communication illustrated in FIG. 11B is an example of a network communication policy to revert development-only policy used in the production phase and including the differences from the development-only network communication policy.

Communication policy generator 12 then generates the communication policy illustrated in FIG. 11B as a communication policy including only the extracted communication IDs. The policy ID is “B” (revert), which is different from FIG. 11A.

In Step S60, communication policy generator 12 generates at least one of the communication policy for external communication or the communication policy for internal communication.

Returning to FIG. 7, next, outputter 16 outputs the generated communication policy (communication policy for external communication and communication policy for internal communication in this example) to vehicle system 30 (S70). The communication policy output here is a communication policy in a format consistent with the corresponding template.

Test program generator 13 may generate a test program for testing the communication policy generated in Step S60, between Steps S60 and S70. For example, test program generator 13 may output a program that selects one or more undefined communications, transmits “10.10.0.y” of eth2, and transmits the communications of communications 3 and 4. The expected results of executing the program include that the communication “10.10.0.y” of eth2 is discarded, and the communications of communications 3 and 4 are not discarded. Outputter 16 may output only communication policies that have passed the test generated by test program generator 13.

Template interpreter 15 may interpret the template in the development phase and generate the communication policy template in the production phase. Template interpreter 15 may read the currently used communication policy template (e.g., the communication policy template in the development phase in FIGS. 8 or 9) and output the communication policy in the production phase in a format consistent with that template.

In the case where policy managers 115a and 115b obtain the communication policy illustrated in FIG. 11A, policy managers 115a and 115b delete the communication policy illustrated in FIG. 9 that had been stored and store the communication policy illustrated in FIG. 11A. For example, policy managers 115a and 115b may overwrite the stored communication policy. In the case where policy managers 115a and 115b obtain the communication policy illustrated in FIG. 11B, policy managers 115a and 115b store the communication policy illustrated in FIG. 11B in addition to the stored communication policy illustrated in FIG. 11A. For example, the communication policies illustrated in FIGS. 11A and 11B may be stored in association with each other.

### Other Embodiments

While an information processing device, etc. according to one or more aspects have been described above by way of the embodiment, the present disclosure is not limited to the embodiment. Other modifications obtained by applying various changes conceivable by a person skilled in the art to the embodiment and any combinations of the elements in different embodiments without departing from the scope of the present disclosure are also included in the scope of the present disclosure.

For example, instead of or in addition to the determination in Step S50 illustrated in FIG. 7 in the above embodiment, whether the communication content and one or more types of network interfaces are to be included in the product may be determined before Step S30. If the communication content and one or more types of network interfaces are not to be included in the product, the communication policy in the production phase need not be generated.

Although the above embodiment describes an example in which a network communication policy to revert development-only policy including the differences from the development-only network communication policy for internal communication is generated as the communication policy for internal communication in the production phase, a network communication policy to revert development-only policy including the differences from the development-only network communication policy for external communication may be generated as the communication policy for external communication in the production phase.

The communication policy (or policies) generated by the policy generation device according to the above embodiment is not limited to being used in a vehicle system, and may be used by any system in which communication is performed using two or more communication protocols or two or more types of network interfaces.

The policy generation device according to the above embodiment may generate a communication policy used for communication between two or more electronic control units included in a system such as a vehicle system. That is, the internal communication may be communication between electronic control units.

In the above embodiment, the obtainer may receive input of a base template that is independent of communication content for each deployment target or communication protocol. The communication policy generator may then interpret the format of the template from the base template and generate a communication policy. The base template is a template for a communication policy that can be interpreted by firewalls with the same deployment target or the same protocol.

In the above embodiment, the template may be obtained from an external device via the obtainer, or may be generated by the template interpreter using a machine learning model. The machine learning model may be a language model, for example, generative artificial intelligence (AI).

Although the above embodiment describes an example in which the default setting of the communication policy is “denied”, the present disclosure is not limited to such, and the default setting may be “allowed”. In such a case, the communication policy includes, as rules, information indicating communications to be denied.

Each structural element in the above embodiment may be configured in the form of an exclusive hardware product, or may be implemented by executing a software program suitable for the structural element. Each structural element may be implemented by means of a program executing unit, such as a CPU or a processor, reading and executing the software program recorded on a recording medium such as a hard disk or semiconductor memory.

The order in which the steps are performed in each flowchart is an example provided for specifically describing the present disclosure, and order other than the above may be used. Part of the steps may be performed simultaneously (in parallel) with one or more other steps, and part of the steps may be omitted.

The division of the functional blocks in each block diagram is an example, and a plurality of functional blocks may be implemented as one functional block, one functional block may be divided into a plurality of functional blocks, or part of functions may be transferred to another functional block. Moreover, functions of a plurality of functional blocks having similar functions may be implemented by single hardware or software in parallel or in a time-sharing manner.

The policy generation device according to the above embodiment may be implemented as a single device or a plurality of devices. In the case where the policy generation device is implemented by a plurality of devices, the structural elements in the policy generation device may be assigned to the plurality of devices in any way. In the case where the policy generation device is implemented by a plurality of devices, the communication method between the plurality of devices is not limited, and may be wireless communication or wired communication. The communication method may be a combination of wireless communication and wired communication.

The structural elements described in the above embodiment may be implemented by software, and may be typically implemented by LSI which is an integrated circuit. The elements may each be individually implemented as one chip, or may be partly or wholly implemented on one chip. While description has been made regarding LSI, there are different names such as IC, system LSI, super LSI, and ultra LSI, depending on the degree of integration. The circuit integration technique is not limited to LSIs, and dedicated circuits (general-purpose circuits that execute dedicated programs) or general-purpose processors may be used to achieve the same. A field programmable gate array (FPGA) which can be programmed after manufacturing the LSI or a reconfigurable processor where circuit cell connections and settings within the LSI can be reconfigured may be used. Further, in the event of the advent of an integrated circuit technology which would replace LSIs by advance of semiconductor technology or a separate technology derived therefrom, such a technology may be used for integration of the elements.

A system LSI is a super-multifunctional LSI manufactured by integrating a plurality of processing units on a single chip, and specifically is a computer system including a microprocessor, read only memory (ROM), random access memory (RAM), and so forth. A computer program is stored in the ROM. The system LSI achieves its functions by the microprocessor operating according to the computer program.

One aspect of the present disclosure may be a computer program for causing a computer to execute each characteristic step included in the information processing method illustrated in FIG. 7.

For example, the program may be a program to be executed by a computer. One aspect of the present disclosure may be a non-transitory computer-readable recording medium having such a program recorded thereon. For example, the program may be recorded on a recording medium and distributed or circulated. For example, by installing the distributed program in another device including a processor and causing the processor to execute the program, the processes can be performed by the device.

### Additional Note

The above description of the embodiment discloses the following technologies.

### Technology 1

An information processing device that generates a network communication policy used in an electronic control unit, the information processing device including: an obtainer that obtains input data including communication content and one or more types of network interfaces, the communication content and the one or more types of network interfaces being used by a program operating on the electronic control unit; a generator that generates the network communication policy including a rule allowing, for the one or more types of network interfaces obtained, communication of the communication content obtained; and an outputter that outputs the network communication policy generated.

In this way, a network communication policy corresponding to communication content and one or more types of network interfaces can be automatically generated. An information processing device capable of easily generating a network communication policy can thus be provided.

### Technology 2

The information processing device according to technology 1, wherein the one or more types of network interfaces are two or more types of network interfaces, and the network communication policy includes whether communication is allowed for each of the two or more types of network interfaces.

In this way, a more complex network communication policy corresponding to two or more types of network interfaces can be automatically generated.

### Technology 3

The information processing device according to technology 1 or technology 2, wherein the obtainer further obtains a deployment target of the program, and the generator generates the network communication policy using a format in accordance with the deployment target.

In this way, a network communication policy in a format in accordance with the deployment target can be automatically generated.

### Technology 4

The information processing device according to any of technology 1 to technology 3, wherein the obtainer further obtains a communication protocol of the communication content, and the generator generates the network communication policy using a format in accordance with the communication protocol.

In this way, a network communication policy in a format in accordance with the communication protocol can be automatically generated.

### Technology 5

The information processing device according to any of technology 1 to technology 4, wherein the obtainer further obtains a deployment target of the program and a communication protocol of the communication content, and the generator generates the network communication policy using a format in accordance with a combination of the deployment target and the communication protocol.

In this way, a network communication policy in a format in accordance with the combination of the deployment target and the communication protocol can be automatically generated.

### Technology 6

The information processing device according to any of technology 1 to technology 5, wherein the obtainer further obtains a threat analysis result indicating whether to protect the communication content, and the generator further identifies communication to be protected based on the threat analysis result, and generates the network communication policy including a rule allowing only the communication identified.

In this way, a network communication policy in which only communication identified based on the threat analysis result is allowed can be automatically generated.

### Technology 7

The information processing device according to any of technology 1 to technology 6, wherein the obtainer further obtains product requirement information indicating whether the communication content and the one or more types of network interfaces are to be included in a product, and the generator further generates, based on the product requirement information, a production network communication policy used in a production phase and a development-only network communication policy used in a development phase.

In this way, it is possible to separately generate a production network communication policy and a development-only network communication policy used in the development phase. Hence, respective network communication policies suitable for the production phase and the development phase can be automatically generated.

### Technology 8

The information processing device according to any of technology 1 to technology 7, wherein the obtainer further obtains product requirement information indicating whether the communication content and the one or more types of network interfaces are to be included in a product, and the generator further generates, based on the product requirement information, a development-only network communication policy used in a development phase and a network communication policy to revert development-only policy used in a production phase and including a difference from the development-only network communication policy.

In this way, the processing amount when generating a network communication policy to revert development-only policy can be reduced.

### Technology 9

The information processing device according to any of technology 1 to technology 8, wherein the obtainer further obtains a general-purpose policy independent of the communication content, and the generator generates the network communication policy including a rule included in the general-purpose policy.

In this way, a network communication policy including one or more rules of a general-purpose policy can be automatically generated.

### Technology 10

The information processing device according to technology 9, wherein the rule included in the general-purpose policy includes a rule related to log output, the obtainer further obtains a setting of the log output, and the generator generates the network communication policy including a rule related to the setting of the log output obtained.

In this way, a network communication policy including a log (communication log) can be automatically generated.

### Technology 11

The information processing device according to technology 5, wherein the obtainer further obtains a plurality of templates of the network communication policy that correspond to either respective deployment targets or respective communication protocols or correspond to both the respective deployment targets and the respective communication protocols, and the generator selects, from the plurality of templates, a template corresponding to at least one of the deployment target obtained or the communication protocol obtained, and generates the network communication policy according to the template selected.

In this way, a network communication policy can be generated using a template that can be handled by a module with firewall function.

### Technology 12

The information processing device according to any of technology 1 to technology 11, wherein the obtainer further obtains a communication log for generating the network communication policy, and the generator generates the network communication policy further including a rule allowing at least one communication included in the communication log.

In this way, a network communication policy with the communication log taken into consideration can be automatically generated. For example, a network communication policy in which specific communication is allowed can be automatically generated.

### Technology 13

The information processing device according to any of technology 1 to technology 12, wherein the generator further generates a test pattern for verifying the network communication policy, and the outputter further outputs the test pattern generated.

In this way, the generated network communication policy can be automatically verified.

### Technology 14

The information processing device according to any of technology 1 to technology 13, wherein the electronic control unit includes either two or more virtual machines or two or more containers, or includes both the two or more virtual machines and the two or more containers, and the network communication policy is applied to at least one of communication between the two or more virtual machines or communication between the two or more containers.

In this way, a network communication policy capable of improving security in communication between virtual machines or between containers can be automatically generated.

### Technology 15

The information processing device according to any of technology 1 to technology 14, wherein the electronic control unit is provided to a vehicle.

In this way, a network communication policy used in an electronic control unit provided to a vehicle can be easily generated.

### Technology 16

An information processing method executed by an information processing device that generates a network communication policy used in an electronic control unit, the information processing method including: obtaining communication content and one or more types of network interfaces, the communication content and the one or more types of network interfaces being used by a program operating on the electronic control unit; generating the network communication policy including a rule allowing, for the one or more types of network interfaces obtained, communication of the communication content obtained; and outputting the network communication policy generated.

This has the same advantageous effects as the foregoing information processing device.

### Technology 17

A non-transitory computer-readable recording medium having recorded thereon a program for causing a computer to execute the information processing method according to technology 16.

This has the same advantageous effects as the foregoing information processing device.

These general and specific aspects may be implemented using a system, a method, an integrated circuit, a computer program, or a non-transitory computer-readable recording medium such as CD-ROM, or any combination of a system, a method, an integrated circuit, a computer program, and a recording medium. The program may be stored in the recording medium beforehand, or supplied to the recording medium via a wide area communication network such as the Internet.

### Further Information about Technical Background to this Application

The disclosure of the following patent application including specification, drawings, and claims is incorporated herein by reference in its entirety: Japanese Patent Application No. 2025-043460 filed on March 18, 2025.

### Industrial Applicability

The present disclosure is useful for an information processing device, etc. that output security measures for an object.

1. An information processing device that generates a network communication policy used in an electronic control unit, the information processing device comprising:
an obtainer that obtains input data including communication content and one or more types of network interfaces, the communication content and the one or more types of network interfaces being used by a program operating on the electronic control unit;
a generator that generates the network communication policy including a rule allowing, for the one or more types of network interfaces obtained, communication of the communication content obtained; and
an outputter that outputs the network communication policy generated.

2. The information processing device according to claim 1,
wherein the one or more types of network interfaces are two or more types of network interfaces, and
the network communication policy includes whether communication is allowed for each of the two or more types of network interfaces.

3. The information processing device according to claim 1,
wherein the obtainer further obtains a deployment target of the program, and
the generator generates the network communication policy using a format in accordance with the deployment target.

4. The information processing device according to claim 1,
wherein the obtainer further obtains a communication protocol of the communication content, and
the generator generates the network communication policy using a format in accordance with the communication protocol.

5. The information processing device according to claim 1,
wherein the obtainer further obtains a deployment target of the program and a communication protocol of the communication content, and
the generator generates the network communication policy using a format in accordance with a combination of the deployment target and the communication protocol.

6. The information processing device according to claim 1,
wherein the obtainer further obtains a threat analysis result indicating whether to protect the communication content, and
the generator further identifies communication to be protected based on the threat analysis result, and generates the network communication policy including a rule allowing only the communication identified.

7. The information processing device according to claim 1,
wherein the obtainer further obtains product requirement information indicating whether the communication content and the one or more types of network interfaces are to be included in a product, and
the generator further generates, based on the product requirement information, a production network communication policy used in a production phase and a development-only network communication policy used in a development phase.

8. The information processing device according to claim 1,
wherein the obtainer further obtains product requirement information indicating whether the communication content and the one or more types of network interfaces are to be included in a product, and
the generator further generates, based on the product requirement information, a development-only network communication policy used in a development phase and a network communication policy to revert development-only policy used in a production phase and including a difference from the development-only network communication policy.

9. The information processing device according to claim 1,
wherein the obtainer further obtains a general-purpose policy independent of the communication content, and
the generator generates the network communication policy including a rule included in the general-purpose policy.

10. The information processing device according to claim 9,
wherein the rule included in the general-purpose policy includes a rule related to log output,
the obtainer further obtains a setting of the log output, and
the generator generates the network communication policy including a rule related to the setting of the log output obtained.

11. The information processing device according to claim 5,
wherein the obtainer further obtains a plurality of templates of the network communication policy that correspond to either respective deployment targets or respective communication protocols or correspond to both the respective deployment targets and the respective communication protocols, and
the generator selects, from the plurality of templates, a template corresponding to at least one of the deployment target obtained or the communication protocol obtained, and generates the network communication policy according to the template selected.

12. The information processing device according to claim 1,
wherein the obtainer further obtains a communication log for generating the network communication policy, and
the generator generates the network communication policy further including a rule allowing at least one communication included in the communication log.

13. The information processing device according to claim 1,
wherein the generator further generates a test pattern for verifying the network communication policy, and
the outputter further outputs the test pattern generated.

14. The information processing device according to claim 1,
wherein the electronic control unit includes either two or more virtual machines or two or more containers, or includes both the two or more virtual machines and the two or more containers, and
the network communication policy is applied to at least one of communication between the two or more virtual machines or communication between the two or more containers.

15. The information processing device according to claim 1,
wherein the electronic control unit is provided to a vehicle.

16. An information processing method executed by an information processing device that generates a network communication policy used in an electronic control unit, the information processing method comprising:
obtaining communication content and one or more types of network interfaces, the communication content and the one or more types of network interfaces being used by a program operating on the electronic control unit;
generating the network communication policy including a rule allowing, for the one or more types of network interfaces obtained, communication of the communication content obtained; and
outputting the network communication policy generated.

17. A non-transitory computer-readable recording medium having recorded thereon a program for causing a computer to execute the information processing method according to claim 16.
